(19) United States
(12) Patent Application Publication
(10) Pub. No.: US 2011/0143838 A1
(43) Pub. Date: Jun. 16, 2011

(54) APPARATUS AND METHOD FOR GAME DESIGN EVALUATION

(75) Inventors: Ki-Suk LEE, Daejeon (KR); Hang-Kee Kim, Daejeon (KR); Hun-Joo Lee, Daejeon (KR); Seong-Won Ryu, Daejeon (KR); Chang-Joon Park, Daejeon (KR)

(73) Assignee: Electronics and Telecommunications Research Institute, Daejeon (KR)

(21) Appl. No.: 12/881,426

(22) Filed: Sep. 14, 2010

(30) Foreign Application Priority Data
Dec. 11, 2009 (KR) 10-2009-0123370

(51) Int. Cl. A63F 13/06; A63F 9/24

(52) U.S. Cl. 463/37; 463/42; 463/43

(57) ABSTRACT

The present invention relates to an apparatus and a method for game design evaluation. The apparatus for game design evaluation includes a operation information input unit that receives the game operation signals of the user, a gamer status input unit that receives status information of the user while the game is played, a gamer status detector that analyzes information collected through the game status information input unit, and a game design evaluator that stores detected data to be used in commercial game software and performs analysis in various manners. With the present invention, it can acquire the degree of the user's interest, taste, and stress through the face and motion of the gamer and the brainwave status of the gamer, the keyboard and mouse input of the user, and the status information in the current playing game and evaluate the design of game contents based on them.

### CROSS REFERENCE TO RELATED APPLICATIONS

This application claims priority to Korean Patent Application No. 10-2009-0123370 filed on Dec. 11, 2009, the entire contents of which are herein incorporated by reference.

### BACKGROUND OF THE INVENTION

1. Field of the Invention

The present invention relates to an apparatus and a method for game design evaluation, and more particularly, to an apparatus and a method for game design evaluation capable of acquiring a degree of user's interest, taste, and stress in a game currently being played, analyzing a degree of user's on the basis of them, and performing design verification of game contents.

2. Description of the Related Art

Recently, more dynamic games have been shown by getting out of a monotonous game progress and providing various game characters and game conditions due to the development of an online game, a mud game, an RPG game, etc.

In order to perform more dynamic games, it is necessary to control various characters and game conditions. This is effectively implemented by an artificial intelligent processing technology that performs decision making through a complex search to provide advanced optimizing solution. In addition, artificial intelligence plays a game with a player instead of a computer while moving away of a conventional format such as an existing computer to a gamer, a gamer to a gamer, etc., or the intelligent game based on so-called artificial intelligent (A.I.) technology for an agent NC (NPC) on behalf of an owner to play a game with other players is being evolved as a future game.

The related art discloses a game system and a game method in which a cyber clone learns owner's inclination is activated. However, Publication Patent refers to probability for each pure input under a specific condition that is not analyzed for each style element of the owners when allowing the cyber clone to learn the owner's tendency.

Since learning is performed based on the probability statistical manner through the pure input operation of the gamer without using heuristical information on why the game should be operated as described above under the gamer tendencies or a specific condition, the validity of the learning result may be degraded and the data to be processed and the processing load have the exponentially increased complexity, thereby increasing the burden of the game system process.

When the game design is performed according to the related art, in order to manufacture more interesting contents to a user, a method depending on the experience of an excellent designer has been mainly used.

However, it is not easy to reflect the designer's intention on the contents as well as it is impossible to quantitatively and qualitatively evaluate delicate portions felt by the real users, such that proper feedback cannot be provided to the designer due to the simplified classification, which is according to the level of fun.

A method of using the design verified through various manners in the template type, that is, a method of creating a game by similarly imitating the well-made game has been mainly used until now.

### SUMMARY OF THE INVENTION

It is an object of the present invention to provide an apparatus and a method for game design evaluation capable of acquiring a degree of garners' interest, taste, and stress and designing and verifying the game contents based on them.

It is another object of the present invention to provide an apparatus and a method for game design evaluation capable of scientifically evaluating on how the created game is accepted by the user.

It is another object of the present invention to provide an apparatus and a method for game design evaluation capable of creating high quality of contents as compared as the related art as well as achieving a new type of game design.

It is another object of the present invention to provide an apparatus and a method for game design evaluation capable of providing information on how large a degree of gamers' interest and stress are under any condition of the created game contents to the game designer.

It is another object of the present invention to provide an apparatus and a method for game design evaluation capable of providing a method of making a game more interesting by allowing a game designer to verify user's game design.

According to an exemplary embodiment of the present invention, there is provided an apparatus for game design evaluation, including: an operational information input unit that receives game operation signals of a user; a gamer status input unit that receives status information of the user while the game is performed; a gamer status detector that analyzes information collected through the operational information input unit and the gamer status input unit; and a game design evaluator that compares information provided through the gamer status detector with information stored in a database to evaluate the game.

The gamer status input unit includes an image input unit that includes a camera to acquire the image of the user while the game is played.

The gamer status detector detects the face and motion of the gamer from the image of the user acquired through the image input unit.

The game design evaluator compares the information on the face and motion of the gamer detected by the gamer status detector with the data stored in the database to extract the emotion of the gamer.

The gamer status input unit further includes a bio signal input unit that includes a brainwave measuring device to acquire the brainwave of the user while the game is performed.

The game design evaluator calculates the concentration of the gamer based on the brainwave to acquire degree of the immersion and interest of the gamer.

The operational information input unit extracts the input signal of the user through at least one of a keyboard and a mouse.

The database stores image data according to variation in emotion by the sex and age of the gamer.

According to another embodiment of the present invention, there is provided a method for game design evaluation, including: acquiring image and bio information of a gamer while a game is performed; extracting status information of a game currently being played; analyzing the image and bio information of the gamer and the status information of the game to detect the status information of the gamer; and comparing the detected status information of the gamer with the information stored in the database to evaluate the game.

The acquiring includes measuring the brainwave of the gamer while the game is played.

The evaluating includes: calculating the concentration of the gamer based on the measured brainwave of the gamer; and determining degree of the corresponding game immersion and interest of the gamer by using the calculated concentration.

The detecting detects the face and motion of the gamer from the image of the gamer while the corresponding game is performed.

The evaluating further includes comparing the detected face and motion of the gamer with the data stored in the database to extract the emotion of the gamer.

The apparatus and method for game design evaluation according to embodiments the present invention can have the following effects.

First, it can generate high-quality of contents as compared to the game design due to the existing experience.

Second, it can save costs by reducing the contents correction due to the indistinct emotions.

Third, it can provide the method for making a game more interesting by allowing the game designer to verify the user's game design.

### BRIEF DESCRIPTION OF THE DRAWINGS

FIG. 1 is a block diagram for explaining a configuration of an apparatus for game design evaluation according to an exemplary embodiment of the present invention;

FIG. 2 is an exemplified diagram for explaining the apparatus for game design evaluation according to an exemplary embodiment of the present invention;

FIG. 3 is a flowchart showing an operational flow of the method for game design evaluation according to an exemplary embodiment of the present invention; and

FIG. 4 is a flow chart showing an operation of evaluating the status of the gamer in the method for game design evaluation according to an exemplary embodiment of the present invention.

### DETAILED DESCRIPTION OF THE PREFERRED EMBODIMENTS

Hereinafter, the configuration of an apparatus and method for game design evaluation according to embodiments of the present invention and the operation thereof will be described.

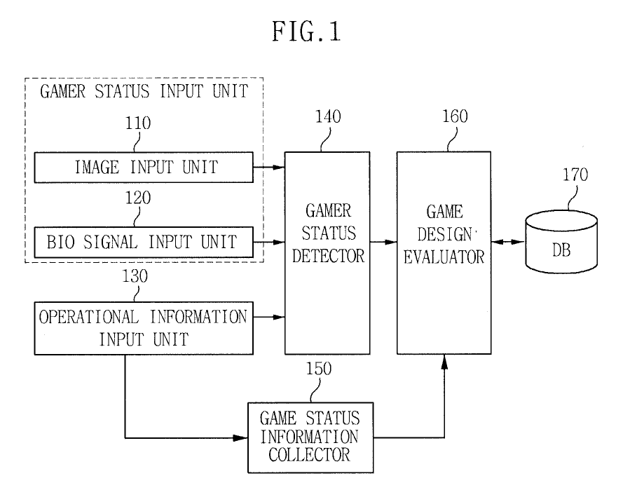

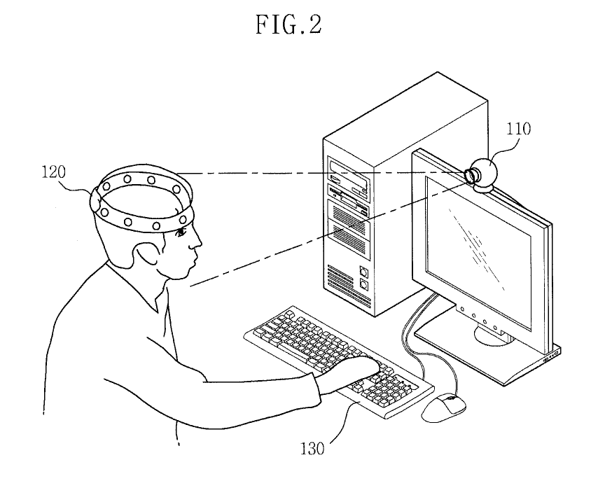

FIG. 1 is a diagram schematically showing a configuration of an apparatus for game design evaluation according to an exemplary embodiment of the present invention and FIG. 2 is an exemplified diagram for explaining the apparatus for game design evaluation according to an exemplary embodiment of the present invention.

As described above, the present invention is a system based apparatus that can confirm reaction of a user, i.e., a gamer. That is, the present invention is based on a human computer interface (HCI) that includes interface data between a gamer and a computer as an essential component operating a system.

Referring to FIGS. 1 and 2, an apparatus for game design evaluation according to the present invention includes a gamer status input unit that includes an image input unit 110 and a bio signal input unit 120, an operational information input unit 130, a gamer status detector 140, a game status information collector 150, a game design evaluator 160, and a database (DB) 170.

The database 170 stores various data necessary for the analysis and determination of the game design evaluator, in addition to the image data according to variation in emotions by sex and age.

The image input unit 110 acquires the face and motion of the gamer from a camera mounted on the system. The gamer status detector 140 extracts color based or edge based features through the image from the image input unit 110 and extracts the emotion through the change in eye and mouth forming the motion and face of the gamer.

The bio signal input unit 120 can use brainwave input apparatuses commercially generated for a current game in order to acquire the brainwave of the gamer from the brainwave input apparatuses.

The gamer status detector 140 uses the brainwave from the bio signal input unit 120 to detect the game concentration of the gamer. Generally, as the concentration becomes high, the immersion and interest of the gamer are increased.

The operational information input unit 130 receives information operating the game from a keyboard and a mouse. The game status information collector 150 collects the game status based on the information input through the operational information input unit 130.

For example, the game status information collector 150 collects information such as a frequency input through the keyboard by the user, classification of used languages, a reaction speed, etc. Until now, input related fundamental technologies have various solutions and use them according to an extracting method. The method may be similarly applied to the information input through the mouse.

The game status information collector 150 includes the interface for acquiring the status information in the game currently being played.

The gamer status detector 140 analyzes the collected information to detect the gamer status, based on the collected information.

The game design evaluator 160 compares the provided information with the information stored in the database 170 to analyze various forms.

As an example, the game design evaluator 160 compares the information on the face and motion of the gamer acquired through the camera with the data stored in the database 170 to extract the emotion of the gamer.

In addition, the game design evaluator 160 uses the concentration extracted based on the brainwave of the gamer acquired through the brainwave input apparatus to compare data stored in the database 170 in respects to the immersion and interest of the gamer.

Thereby, the game design evaluator 160 finally evaluates the game based on the status of the gamer for the game currently being played and outputs the results.

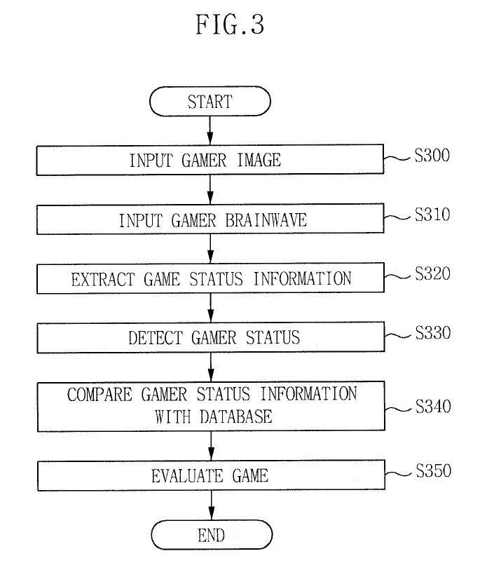

FIG. 3 is a flowchart showing an operational flow of the method for game design evaluation according to an exemplary embodiment of the present invention.

As shown in FIG. 3, the image input unit 110 acquires the current image of the gamer performing the game by using the camera, and the like (S300). In addition, the bio signal input unit 120 measures the brainwave of the gamer by using the brainwave input apparatus to extract the bio information (S310).

Meanwhile, the signal operated by the keyboard or the mouse, etc., is received through the operational information input unit 130 while the game is performed.

At this time, the game status information collector 150 collects the information such as the frequency input through the keyboard, the classification of the used languages, the reaction speed, etc., based on the information input through the operational information input unit 130 (S320).

In addition, the gamer status detector 140 analyzes the image, bio information, and game operation signals of the gamer acquired in steps ‘S300’ to ‘S320’ to detect the status of the gamer (S330).

The game design evaluator 160 collects and analyzes the information acquired in steps ‘S320’ and ‘S330’. At this time, the game design evaluator 160 compares the status information of the gamer detected in step ‘S330’ with the information stored in the database (S340) and extracts the analysis results in various forms for the game based on the comparison results (S350).

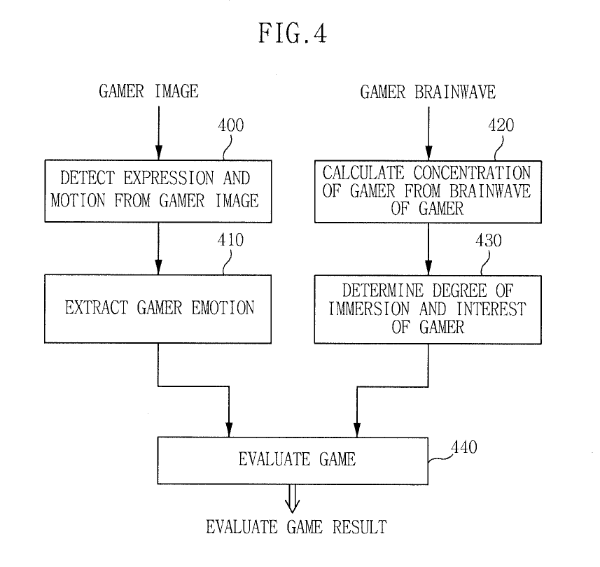

FIG. 4 is a flow chart showing an operation of evaluating the status of the gamer in the method for game design evaluation according to an exemplary embodiment of the present invention.

As shown in FIG. 4, when the gamer status detector 140 is input from the image input unit 110, the face and motion of the gamer are detected from the input image (400). At this time, the emotion of the gamer is extracted according to the change in the face and motion of the gamer (410).

Meanwhile, the bio signal input unit 120 uses the brainwave acquired from the brainwave input apparatus to calculate the game concentration of the gamer (420) and determines degree of the immersion and interest of the gamer according to the result (430).

Finally, the game design evaluator 160 evaluates the game based on the emotion of the gamer extracted from the gamer image and the immersion and interest of the gamer acquired from the garners' brainwave (440).

As described above, the apparatus for controlling component of application and the method thereof according to the present invention is not limited to the configuration and method of the embodiments described as above, but the embodiments may be configured by selectively combining all the embodiments or some of the embodiments so that various modifications can be made.

What is claimed is:

1. An apparatus for game design evaluation, comprising:
an operational information input unit that receives game operation signals of a user;
a gamer status input unit that receives status information of the user while the game is played;
a gamer status detector that analyzes information collected through the operational information input unit and the gamer status input unit; and
a game design evaluator that compares information provided through the gamer status detector with information stored in a database to evaluate the game.

2. The apparatus for game design evaluation according to claim 1, wherein the gamer status input unit includes an image input unit that includes a camera to acquire the image of the user while the game is performed.

3. The apparatus for game design evaluation according to claim 2, wherein the gamer status detector detects the face and motion of the gamer from the image of the user acquired through the image input unit.

4. The apparatus for game design evaluation according to claim 3, wherein the game design evaluator compares the information on the face and motion of the gamer detected by the gamer status detector with the data stored in the database to extract the emotion of the gamer.

5. The apparatus for game design evaluation according to claim 1, wherein the gamer status input unit further includes a bio signal input unit that includes a brainwave measuring device to acquire the brainwave of the user while the game is played.

6. The apparatus for game design evaluation according to claim 5, wherein the game design evaluator calculates the concentration of the gamer based on the brainwave to acquire degree of the immersion and interest of the gamer.

7. The apparatus for game design evaluation according to claim 1, wherein the operational information input unit extracts the input signal of the user through at least one of a keyboard and a mouse.

8. The apparatus for game design evaluation according to claim 1, wherein the database stores image data according to variation in the emotions by the sex and age of the gamer.

9. A method for game design evaluation, comprising:
acquiring image and bio information of a gamer while a game is performed;
extracting status information of a game currently being played;
analyzing the image and bio information of the gamer and the status information of the game to detect the status information of the gamer; and
comparing the detected status information of the gamer with the information stored in the database to evaluate the game.

10. The method for game design evaluation according to claim 9, wherein the acquiring includes measuring the brainwave of the gamer while the game is played.

11. The method for game design evaluation according to claim 10, wherein the evaluating includes:
calculating the concentration of the gamer based on the measured brainwave of the gamer; and
determining degree of the corresponding game immersion and interest of the gamer by using the calculated concentration.

12. The method for game design evaluation according to claim 9, wherein the detecting detects the face and motion of the gamer from the image of the gamer while the corresponding game is performed.

13. The method for game design evaluation according to claim 12, wherein the evaluating further includes comparing the detected face and motion of the gamer with the data stored in the database to extract the emotion of the gamer.
